(19) United States
(12) Patent Application Publication
(10) Pub. No.: US 2008/0069949 A1
(43) Pub. Date: Mar. 20, 2008

(54) SILANE-FUNCTIONAL, CHLORINE-FREE COMPOSITION

(75) Inventors: Patrick Glockner, Haltern am See (DE); Lutz Mindach, Bochum (DE); Hinnerk Gordon Becker, Essen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/855,199

(22) Filed: Sep. 14, 2007

(30) Foreign Application Priority Data
Sep. 15, 2006 (DE) 102006044143.5

(51) Int. Cl. C08F 255/00; B05D 1/02; B05D 1/18; B05D 1/36; B05D 3/12

(52) U.S. Cl. 427/240; 427/407.1; 427/427.6; 427/428.01; 427/430.1; 524/588; 525/69

(57) ABSTRACT

A compositions containing A) a silane-grafted, largely amorphous poly-α olefin which contains no organically bound chlorine, B) a ketone resin, ketone/aldehyde resin and/or urea/aldehyde resin and/or their hydrogenated derivatives, C) a solvent and D) optionally an auxiliary and/or additive, can be used as primers for promoting the adhesion of coating materials such as paints, varnishes, adhesives, sealants and inks, including printing inks, for example, to plastics, wood, paper, metals, glass, ceramics and concrete.

### BACKGROUND OF THE INVENTION

1. Field of the Invention

The present invention relates to a composition comprising A) a silane-grafted, largely amorphous poly-α olefin which contains no organically bound chlorine and has an enthalpy of fusion in the range from 0 to 80 J/g, B) a ketone resin, ketone/aldehyde resin and/or urea/aldehyde resin and/or its hydrogenated derivative, C) a solvent and D) optionally an auxiliary and/or additive, and to its use as primer for promoting the adhesion of coating materials such as paints, varnishes, adhesives and sealants and also inks, including printing inks, for example, to plastics, wood, paper, metals, glass, ceramic and concrete.

2. Description of the Related Art

It is known that ketones, or mixtures of ketones and aldehydes, can be reacted, in the presence of basic catalysts or acids, to form resinous products. For instance, mixtures of cyclohexanone and methylcyclohexanone can be used to prepare resins (Ullmann Vol. 12, p. 551). The reaction of ketones and aldehydes usually results in hard resins, which are often employed in the coatings industry.

Industrially significant ketone-aldehyde resins are nowadays usually prepared using formaldehyde.

Ketone-formaldehyde resins are already well established. Preparation processes are described for example in DE 102006009080.2 and also in the patents it cites.

The preparation normally involves reacting ketones and formaldehyde with one another in the presence of bases.

Ketone resins, ketone/aldehyde resins and/or urea/aldehyde resins and their hydrogenated derivatives are employed in coating materials as, for example, film-forming addition components, in order to enhance certain properties such as rate of initial drying, gloss, hardness or scratch resistance. On account of their relatively low molecular weight, typical ketone, ketone/aldehyde and/or urea/aldehyde resins and/or their hydrogenated derivatives possess a low melt viscosity and solution viscosity and are therefore used as film-forming functional fillers, among other things, in coating materials.

As a result, for example, of exposure to sunlight, for example, the carbonyl groups of the ketone/aldehyde resins are subject to conventional degradation reactions, such as those of Norrish type I or II, for example.

It is therefore not possible to use unmodified ketone/aldehyde resins or ketone resins for high-quality applications in the exterior sector, for example, where high resistance properties, particularly in respect of weathering and heat, are required. These disadvantages can be remedied by hydrogenating the carbonyl groups. The conversion of the carbonyl groups into secondary alcohols by hydrogenation of ketone-aldehyde resins has been practised for a long time (DE 870 022).

The preparation of carbonyl-hydrogenated and ring-hydrogenated ketone-aldehyde resins on the basis of ketones containing aromatic groups is likewise possible. Resins of this kind are described in DE 102006026758.3 or DE 102006026760.5.

The preparation and use of silane-grafted, largely amorphous poly-α-olefins are already well established. Many are described in, for example, EP 827 994 and DE-A 40 00 695.

In none of these applications is there a reference to the use of primer compositions that are based on silane-grafted, largely amorphous poly-α-olefins which contain no organically bound chlorine and on ketone resins, ketone/aldehyde resins and/or urea/aldehyde resins and/or their hydrogenated derivatives and that allow very good adhesion of coating materials to unpretreated plastics, for example.

For the coating of apolar plastics they are usually pretreated in order to obtain sufficiently high adhesion of the coating to the plastic. For example, plastics comprising polyolefins, such as those of polypropylene (PP), modified polypropylene (e.g. polypropylene-ethylene copolymers), polyethylene (PE), modified PE, mixtures such as e.g. polypropylene/ethylene-propylene-diene blends (PP/EPDM) having a low EPDM content, PP/PE blends or specific polyesters, are pretreated by defined methods so that the coating material adheres to the plastic. Typical methods are flame treatment, corona discharge, gas-phase fluorination or plasma treatment. These methods cause partial oxidation of the plastic's surface, so that the surface tension goes up. As a result of this, subsequent coatings or adhesive bonds are able to form intermolecular interactions with respect to the substrate, thereby enhancing the adhesion. The disadvantages of these methods lie in the high costs and in the fact that the effect of the pretreatment subsides over a relatively short time period (a few days to weeks). Moreover, corona-pretreated plastics have a tendency towards blocking, so that this pretreatment method can in principle only take place inline with the application of the coating material.

Other methods, such as the addition of adjuvants for promoting the adhesion during the production of the plastic, are likewise possible. The disadvantages of such methods lie in the relatively high costs and in the fact that the adjuvants, which are of lower molecular weight, may cause problems during the production of the plastic and may adversely affect the physical properties such as the mechanical strengths, for example.

Another pretreatment option is the application of primers to the plastic prior to the application of the coating material.

US 2003/055163 describes binder compositions whose constituents include chlorinated, COOH-containing polyolefins and ketone resins.

JP 46027878 likewise describes compositions which as well as ketone resins contain chlorinated polyolefins.

Products which contain organically bound chlorine can give off hydrochloric acid and highly toxic dioxins, for example, may form in the course of their combustion. Consequently, methods of this kind are unadvisable on grounds of occupational hygiene and environmental protection.

WO 2004/078365 describes primers based on silane-modified polyolefins. The disadvantageous results of the low glass transition temperature of the polyolefins and of the low crystallinity include slow initial drying and no blocking resistance. This means that, on the one hand, the productivity in the case of continuous processing (as in the case of printing inks or coil coatings, for example) is low because of the slow initial drying. On the other hand, off-line coating of the substrate with the primer, and further coating with the printing ink or paint at a later point in time, is impossible because of the low, deficient blocking resistance, which causes sticking. As is apparent from the examples of WO 2004/078365, effective adhesion is obtainable only if the coated substrates are exposed to a relatively high temperature. For thermally unstable substrates this is not an option.

### SUMMARY OF THE INVENTION

It was an object of the present invention to provide a composition, based on poly-α-olefin and ketone, ketone/aldehyde and/or urea/aldehyde resin and/or its hydrogenated derivative, which in particular allows very good adhesion of coating materials to un-pretreated plastics even at room temperature. The compositions ought to be free from chlorine and ought to exhibit rapid initial drying and high blocking resistance. The effect of the pretreatment ought also to be retained over a long time period, so that, optionally, pretreatment directly after the production of the plastic at the premises of the plastic's manufacturer (off-line) or else pretreatment directly prior to the application of the coating material (in-line) is possible. Additionally the adhesion to the substrate and to subsequent coats, even at high temperature, ought to be strong.

This and other objects have been achieved by the present invention the first embodiment of which includes a silane-group-containing composition, comprising:
no organically bound chlorine;
A) 1% to 98% by weight of at least one silane-grafted, largely amorphous poly-α-olefin which comprises no organically bound chlorine and has an enthalpy of fusion in the range from 0 to 80 J/g;
B) 1% to 98% by weight of at least one resin selected from the group consisting of ketone resin, ketone/aldehyde resin, urea/aldehyde resin, hydrogenated ketone resin, hydrogenated ketone/aldehyde resin, hydrogenated urea/aldehyde resin and mixtures thereof;
C) 1% to 98% by weight of at least one solvent; and
D) optionally, up to 97% by weight of at least one auxiliary or adjuvant, the sum of components A) to D) being 100% by weight.

Another embodiment includes a process for preparing the above silane-group-containing composition, comprising:

by intensely mixing and homogenizing components A) to C) and optionally D) by stirring and/or dispersing at a temperature of +20 to +80° C., optionally in an inert-gas atmosphere and with exclusion of water, component C) being introduced initially and components A), B) and, optionally, D) being added.

Yet another embodiment provides a method of promoting adhesion to a plastic, comprising:

contacting said plastic with the above silane-group-containing composition, thereby obtaining a coating.

Further, the present invention includes an embodiment of a method of promoting adhesion to a material, comprising:

contacting said material with the above silane-group-containing composition;

wherein said material is selected from the group consisting of glass, wood, paper, cardboard packaging of all kinds, fiber board, metals, ceramic, concrete and combinations thereof.

The present invention also relates to an article, comprising: the above silane-group-containing composition.

### DETAILED DESCRIPTION OF THE INVENTION

One object of the present invention is achieved, surprisingly, by the application to the substrate, prior to application of the coating material, of a composition based on silane-grafted, largely amorphous poly-a-olefin and on ketone, ketone/aldehyde and/or urea/aldehyde resin and/or its hydrogenated derivative, this composition being described in greater detail below.

In contrast to the related art the compositions of the invention are free from organically bound chlorine. They exhibit rapid initial drying and high blocking resistance. The effect of the pretreatment is also constant over a long time period.

The compositions of the invention can therefore be used in particular for improving the adhesion of coating materials to plastics. This adhesion is obtained even under a temperature load.

The present invention provides compositions containing no organically bound chlorine and substantially containing
A) 1% to 98% by weight of at least one silane-grafted, largely amorphous poly-α-olefin which contains no organically bound chlorine and has an enthalpy of fusion in the range from 0 to 80 J/g and
B) 1% to 98% by weight of at least one ketone resin, ketone/aldehyde resin and/or urea/aldehyde resin and/or hydrogenated derivative thereof and
C) 1% to 98% by weight of at least one solvent and if desired
D) up to 97% by weight of at least one auxiliary or adjuvant, the sum of the weight figures of components A) to D) being 100% by weight.

The % by weight are given based on the total weight of the composition. It has been found that the combination of the compositions described below, made up of the components A) to D), meet all of the required criteria.

Component A)

The component A) is used in amounts of 1% to 98%, preferably of 1% to 49%, more preferably 1% to 40% by weight. The amount of component A) includes all values and subvalues therebetween, especially including 5, 10, 15, 20, 25, 30, 35, 40, 45, 50, 55, 60, 65, 70, 75, 80, 85, 90 and 95% by weight. Mixtures of A) may be used.

The silane-grafted, largely amorphous poly-α-olefins which contain no organically bound chlorine and have an enthalpy of fusion in the range from 0 to 80 J/g, are prepared by grafting unsaturated silanes onto the largely amorphous polyolefins.

Largely amorphous poly-α-olefins used may for example be homopolymers, such as atactic polypropylene (APP) or atactic polybut-1-ene, or, preferably, copolymers and/or terpolymers having the following monomer composition:

0% to 95%, preferably 3% to 95% by weight of one or more α-olefins having 4 to 20 carbon atoms,

5% to 100%, preferably 5% to 97% by weight of propene, and

0% to 50%, preferably 0% to 20% by weight of ethene.

The % by weight are based on the monomer composition.

The amount of α-olefins in the monomer composition includes all values and subvalues therebetween, especially including 5, 10, 15, 20, 25, 30, 35, 40, 45, 50, 55, 60, 65, 70, 75, 80, 85, and 90% by weight.

The amount of propene includes all values and subvalues therebetween, especially including 10, 15, 20, 25, 30, 35, 40, 45, 50, 55, 60, 65, 70, 75, 80, 85, 90 and 95% by weight.

The amount of ethene includes all values and subvalues therebetween, especially including 5, 10, 15, 20, 25, 30, 35, 40, and 45% by weight.

As α-olefin having 4 to 20 carbon atoms it is preferred to use 1-butene, 1-pentene, 1-hexene, 1-octene, 1 decene, 1-dodecene, 1-octadecene, 3-methyl-1-butene, a methylpentene such as 4-methyl-1-pentene, for example, a methylhexene or a methylheptene, alone or in a mixture.

The preparation of polymers of this kinds is described for example in EP-A-0 023 249.

These non-modified, largely amorphous poly-α-olefins possess an enthalpy of fusion in the range from 0 to 80 J/g, preferably in the range from 1 to 70 J/g, more preferably in the range from 1 to 60 J/g.

The enthalpy of fusion is a measure of the crystallinity of the polymer. The poly-α-olefins have a relatively low crystallinity, i.e. they are largely, though not completely, amorphous. A certain crystallinity is present, and is vital for the physical properties required. The crystalline regions that are detectable in the course of melting extend over a large temperature range from 0 to 175° C. and in terms of intensity they vary according to position. The poly-α-olefins are distinguished in their crystallinity by the occurrence of not only monomodal but also bimodal and multimodal melting peaks, some of which are sharply divided and others of which merge into one another. The enthalpy of fusion (as a yardstick for the overall crystallinity) of the polymers is between 0 J/g and 80 J/g, preferably in the range from 1 to 70 J/g, more preferably in the range from 1 to 60 J/g.

As a result of the low crystallinity it is possible to achieve on the one hand a high transparency and on the other hand a flexible mechanical behavior. On the other hand, however, an exceptional combination of advantageous material properties can be achieved through a higher crystallinity. Polymers of the invention with relatively high crystallinities, such as polybutene or butene copolymers with high butene fractions, for example, have very good tensile strengths, for example. At the same time their surface tack is relatively low.

The enthalpy of fusion of the crystalline fraction is determined via differential calorimetry (DSC) in accordance with DIN 53 765, from the 2nd heating curve with a heating rate of 10 K/min.

The silane for graft attachment possesses preferably three alkoxy groups joined directly to the silicon. Examples include vinyltrimethoxysilane (VTMO), vinyltriethoxysilane, vinyltris(2 methoxyethoxy)silane, 3-methacryloyloxypropyltrimethoxysilane (MEMO), 3-methacryloyloxypropyltriethoxysilane, vinyldimethylmethoxysilane or vinylmethyldibutoxysilane. For grafting, the silane is used typically in amounts between 0.1% and 10%, preferably between 0.5 and 5%, by weight, based on the polyolefin.

For the preparation of the silane-grafted, largely amorphous poly-α-olefins which contain no organically bound chlorine and have an enthalpy of fusion in the range from 0 to 80 J/g, the unsaturated silanes are grafted onto the largely amorphous polyolefins by any prior-art method, in solution for example or, preferably, in the melt, in the presence of a sufficient amount of a free-radical donor. One suitable procedure can be found in DE-A 40 00 695.

The silane-grafted, largely amorphous poly-α-olefins which contain no organically bound chlorine possess in their non-crosslinked state the following properties:
a weight-average molecular weight of 2000 to 250 000 g/mol, preferably 3000 to 150 000 g/mol, more preferably 3000 to 125 000 g/mol,
a polydispersity, PD, of 2.0 to 40, preferably 2.5 to 20, more preferably 2.5 to 15,
a glass transition temperature, Tg, of −80 to 0° C., preferably −60 to 0° C., more preferably −55 to 10° C.,
an enthalpy of fusion in the range from 0 to 80 J/g, preferably in the range from 1 to 60 J/g, more preferably in the range from 1 to 40 J/g, and
substantial solubility and/or swellability in apolar solvents.

The properties here may take on all possible variations within the abovementioned values, such as a PD of 2.5 to 15 (smallest range) and a Tg of 80 to 0° C. (largest range), for example.

The molecular weight and the polydispersity are determined via high-temperature GPC. The determination is carried out in accordance with ASTM D6474-99, but at a higher temperature (160° C. instead of 140° C.) and with a smaller injection volume, of 150 μl instead of 300 μl. The solvent used is trichlorobenzene. The measurement is made with a column temperature of 160° C. The universal calibration, used in this method for evaluating the elution plots, is carried out on the basis of polyolefin standards. The results are not comparable with measurements calibrated on the basis of extraneous polymers—polystyrene-based polymers, for example—or those without universal calibration, since otherwise there is an impermissible comparison of different three-dimensional polymer structures and/or hydrodynamic radii. Likewise impermissible is the comparison with measurements which use solvents other than the stated solvent, since in different solvents there may be different three-dimensional polymer structures and/or hydrodynamic radii, which lead to a different result of the molecular weight determination.

The polydispersity PD is defined as the ratio of number-average to weight-average molar mass. It is a measure in particular of the breadth of the molar mass distribution that is present, which in turn allows conclusions to be drawn concerning the polymerization characteristics that are present and also concerning the catalyst that is used. In addition it is a measure as well of the low molecular mass fraction present, which in turn affects the adhesion properties of the polymer materials. Within certain limits, the polydispersity is characteristic for a particular catalyst/cocatalyst combination. The molar mass distribution, depending on the procedure used (e.g. 1, 2 or more stirred tanks or combinations of stirred tank and flow tube) and reaction regime (single or multiple metering of catalyst, cocatalyst and monomers), may be either monomodal, bimodal or multimodal. The polydispersity has a relatively strong influence on the tack of the material at room temperature and also on the adhesion.

Furthermore, molecular weight and polydispersity are among the factors exerting a strong influence over solution viscosity, mechanical properties and adhesion properties. The lower the molecular weight, the lower the viscosity in solution. However, at low molecular weight, there may be negative effects on mechanical properties. In order to obtain optimum properties, therefore, the weight-average molecular weight of component A) is between 2000 and 250 000 g/mol, preferably between 3000 and 150 000 g/mol, more preferably between 3000 and 125 000 g/mol, and the polydispersity is between 2.0 and 40, preferably between 2.5 and 20, more preferably between 2.5 and 15.

The glass transition temperature and the melting range of the crystalline fraction are determined via differential calorimetry (DSC) in accordance with DIN 53 765, from the 2nd heating curve with a heating rate of 10 K/min. The point of inflexion of the curve of heat flow is evaluated as the glass transition temperature. The glass transition temperature can be controlled in a known way via the monomer composition and the reaction conditions. Generally speaking, the use of longer-chain monomers results in lower glass transition temperatures. Similarly, reaction conditions in which shorter-chain polymers are also formed (at relatively high polymerization temperatures, for example) also lead, within a certain frame, to a lowering of the glass transition temperature.

A low glass transition temperature Tg impacts favorably on the (low-temperature) flexibility, but negatively on the blocking resistance and on a rapid rate of initial drying (solvent retention time).

The Tg of component A) is therefore chosen so that it is situated between −80 and 0° C., preferably between −60 and 0° C., more preferably between −55 and −10° C.

The enthalpy of fusion is determined as described above and for the reasons described above is situated within the range from 0 to 80 J/g, preferably in the range from 1 to 60 J/g more preferably in the range from 1 to 40 J/g.

Solubility and/or swellability in apolar solvents is desired in order that component A) can be processed. On the one hand, component A) ought to be homogeneously miscible in combination with components B) to D), while on the other hand the composition made up of A) to D) ought to be easy to apply by common methods, such as spraying, printing, pouring, spreading or sponge application, for example.

The solubility is determined by dissolving component A) in the respective solvent or solvent mixture in 10% or 50% dilution, with stirring at reflux temperature, and subsequently cooling the solution to room temperature. The solubility of component A) in xylene is between 80% and 99.9%, preferably between 85% and 99.5% and more preferably between 90% and 99.0%. Furthermore, component A) is soluble in aromatic solvents such as, for example, toluene, benzene, cresols, naphthalene, tetrahydronaphthalene and/or in aliphatic solvents and solvent mixtures, such as decahydronaphthalene, hexane, heptane, cyclohexane, Kristalloels, white spirits, terpentines, paraffins, alone or in a mixture.

“Substantial solubility and/or swellability” of component A) in apolar solvents includes a solubility and/or swellability of between 80% and 99.9%.

Component B)

The component B) is used in amounts of 1% to 98%, preferably of 1% to 49%, more preferably 1% to 40% by weight. The amount of component B) includes all values and subvalues therebetween, especially including 5, 10, 15, 20, 25, 30, 35, 40, 45, 50, 55, 60, 65, 70, 75, 80, 85, 90 and 95% by weight. Mixtures of B) may be used.

These products are responsible in particular for a rapid initial drying rate (improved solvent retention) and a high blocking resistance. In one embodiment, the coating can be applied “wet-in-wet” on the primer layer, i.e. directly after application of the primer. In this case, the high initial drying rate is that the primer is dust free within 10 min, preferably within 5 min.

Furthermore, the use of components B) improves the compatibility with subsequent coating materials in the event of wet-on-wet application, and also improves the adhesion of the subsequent coatings to the primer coat. Not least, the solubility of component A) of the composition of the invention is increased through the presence of component B), and the flow and also the solids fraction are improved.

Suitability as component B) is possessed by ketone resins, ketone/aldehyde resins and/or urea/aldehyde resins and their hydrogenated derivatives, alone or in a mixture.

In general it is possible to use all ketones specified in the literature as being suitable for ketone and ketone-aldehyde resin syntheses, generally speaking all C—H-acidic ketones.

Ketones suitable for preparing the ketone and ketone-aldehyde resins (component B)) include all ketones, more particularly acetone, acetophenone, methyl ethyl ketone, tert-butyl methyl ketone, heptan-2-one, pentan-3-one, methyl isobutyl ketone, cyclopentanone, cyclododecanone, mixtures of 2,2,4- and 2,4,4-trimethylcyclopentanone, cycloheptanone and cyclooctanone, cyclohexanone and all alkyl-substituted cyclohexanones having one or more alkyl radicals which in total have 1 to 8 carbon atoms, individually or in a mixture. Examples that may be given of alkyl-substituted cyclohexanones include 4 tert-amylcyclohexanone, 2-sec-butylcyclohexanone, 2-tert-butylcyclohexanone, 4-tert-butylcyclohexanone, 2-methylcyclohexanone and 3,3,5-trimethylcyclohexanone.

Preference is given to ketone-aldehyde resins based on the ketones acetophenone, cyclohexanone, 4-tert-butylcyclohexanone, 3,3,5-trimethylcyclohexanone and heptanone, alone or in a mixture, and also to ketone resins based on cyclohexanone.

Suitable aldehyde components of the ketone-aldehyde resins (component B)) include, in principle, unbranched or branched aldehydes, such as formaldehyde, acetaldehyde, n-butyraldehyde and/or isobutyraldehyde, valeraldehyde and dodecanal, for example. In general it is possible to use all of the aldehydes that are said in the literature to be suitable for ketone resin syntheses. Preference, however, is given to using formaldehyde, alone or in mixtures.

The formaldehyde required is typically used as an aqueous or alcoholic (e.g. methanol or butanol) solution with a strength of about 20% to 40% by weight. Other forms of formaldehyde, such as the use of para-formaldehyde or trioxane, for example, are also possible. In principle, however, all formaldehyde donor compounds are suitable. Aromatic aldehydes, such as benzaldehyde, may likewise be present in a mixture with formaldehyde.

Particularly preferred starting compounds used for the ketone-aldehyde resins are acetophenone, cyclohexanone, 4-tert-butylcyclohexanone, 3,3,5-trimethylcyclohexanone and heptanone, alone or in a mixture, and formaldehyde.

The molar ratio between the ketone and the aldehyde component is between 1:0.25 to 1:15, preferably between 1:0.9 to 1:5 and more preferably between 1:0.95 to 1:4.

Processes for preparing the ketone-aldehyde resins are described for example in EP 1 486 520, DE 102006009079.9 and DE 102006009080.2 and in the literature they cite.

Likewise used as component B) are hydrogenated derivatives of the resins formed from ketone and aldehyde. The above-described ketone-aldehyde resins are hydrogenated with hydrogen in the presence of a catalyst at pressures of up to 300 bar. In the course of this hydrogenation the carbonyl group of the ketone-aldehyde resin is converted into a secondary hydroxyl group. Depending on the reaction conditions, some of the hydroxyl groups may be eliminated, resulting in methylene groups. The following scheme serves for illustration:

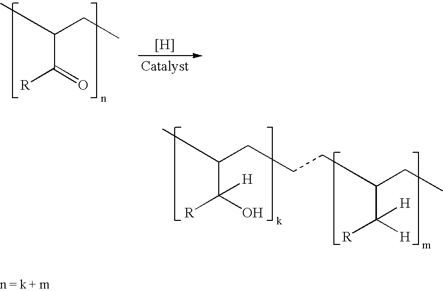

Processes for preparing the hydrogenated products are described for example in DE 102006009079.9 and DE 102006009080.2

In the case of ketones which contain aromatic structural elements, those structural elements too may be hydrogenated depending on the hydrogenation conditions. Suitable resins are described for example in DE 102006026760.5 and DE 102006026758.3.

As component B) use is made, furthermore, of urea-aldehyde resins using a urea of the general formula (i)

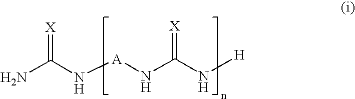

in which X is oxygen or sulphur, A is an alkylene radical and n is 0 to 3 with 1.9(n+1) to 2.2(n+1) mol of an aldehyde of the general formula (ii)

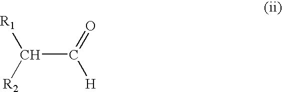

in which R₁ and R₂ stand for hydrocarbon radicals (e.g. alkyl, aryl and/or alkylaryl radicals) having in each case up to 20 carbon atoms

and/or formaldehyde.

Suitable ureas of the general formula (i) with n=0 are, for example, urea and thiourea, with n=1 methylenediurea, ethyleneurea, tetramethylenediurea and/or hexamethylenediurea and also mixtures thereof. Preference is given to urea.

Suitable aldehydes of the general formula (ii) are, for example, isobutyraldehyde, 2-methylpentanal, 2-ethylhexanal and 2-phenylpropanal and also mixtures thereof. Preference is given to isobutyraldehyde.

Formaldehyde can be used in aqueous form, which in part or in whole may also contain alcohols such as methanol or ethanol, for example, or else as para-formaldehyde and/or trioxane.

In general all monomers described in the literature for the preparation of urea-aldehyde resins B) are suitable. Particular preference is given to urea, isobutyraldehyde and formaldehyde.

Typical modes of preparation and compositions are described in, for example, DE 27 57 220, DE-A 27 57 176 and EP 0 271 776. Commercial products are Laropal® A81 or Laropal® A 101 from BASF AG.

Component B) is characterized by
a hydroxyl number between 0 and 450 mg KOH/g, preferably between 0 and 375 mg KOH/g, more preferably between 0 and 350 mg KOH/g,
a Gardner color number (50% by weight in ethyl acetate) between 0 and 5, preferably between 0 and 3.0, more preferably between 0 and 2.0,
a Gardner color number (50% by weight in ethyl acetate) after thermal exposure of the resin (24 h, 150° C.) between 0 and 10.0, preferably between 0 and 7.5, more preferably between 0 and 5.0,
a number-average molecular weight, Mn, of 300 to 10 000 g/mol, preferably of 400 to 5000 g/mol, more preferably of 400 to 3000 g/mol,
a polydispersity (Mw/Mn) between 1.25 and 4.0, more preferably between 1.3 and 3.5,
a melting point/range between 20 and 180° C., preferably between 30 and 140° C., more preferably between 40 and 130° C.,
solubility in apolar organic solvents.

Here as well the properties can be varied arbitrarily.

The hydroxyl number is a measure of the polarity of the resins. The higher it is, assuming otherwise constant parameters of resin properties (e.g. carbonyl number, molecular weight), the higher the polarity. To ensure high compatibility with component A), the hydroxyl number must be chosen to be sufficiently low as to allow solubility in apolar solvents. On the other hand, the more polar the primer, the better the adhesion of subsequent coats to the primer coat. The optimum hydroxyl number lies between 0 and 450 mg KOH/g, preferably between 0 and 375 mg KOH/g, more preferably between 0 and 350 mg KOH/g. The determination is made in accordance with DIN 53240-2“Determination of hydroxyl number”. In the course of the determination it should be ensured that an acetylation time of 3 h exactly is observed.

The Gardner color number is determined in 50% strength by weight solution of component B) in ethyl acetate, in accordance with DIN ISO 4630, and is a measure of the color of the resin. The lower the color number, the closer the resin is to colorless. The color number following thermal exposure is likewise determined in this way. This method can be used to obtain an indication of the heat resistance of component B). For this purpose component B) is first stored in an air atmosphere at 150° C. for 24 h (see Determination of non-volatile fraction). Then the Gardner color number is determined in 50% strength by weight solution of the thermally exposed resin in ethyl acetate, in accordance with DIN ISO 4630. The lower the color number, the more heat-resistant the resin.

The molecular weight and the polydispersity of component B) are measured by means of gel permeation chromatography in tetrahydrofuran against polystyrene as the standard. The polydispersity (Mw/Mn) is calculated from the ratio of the weight average (Mw) to the number average (Mn).

The higher the molecular weight, the higher the melting range of component B) and the better the initial drying rate, but also the higher the solution viscosity. For a given molecular weight (Mn), the solution viscosity becomes higher as the dissolved polymer becomes less uniform (high polydispersity).

Ideally the number-average molecular weight Mn is between 300 and 10 000 g/mol, preferably between 400 and 5000 g/mol, more preferably between 400 and 3000 g/mol, and the polydispersity (Mw/Mn) is between 1.25 and 4.0, more preferably between 1.3 and 3.5.

A maximum melting range of component B) is desirable, in order, for example, that the initial drying rate of the composition of the invention and the hardness and blocking resistance of the coatings are very high.

The determination is made using a capillary melting point measuring instrument (Büchi B-545) in accordance with DIN 53 181. The preferred melting point/range of component B) is between 20 and 180° C., preferably between 30 and 140° C., more preferably between 40 and 130° C.

Component B) is soluble in typical organic solvents such as, for example, ethyl acetate, butyl acetate, acetone, butanone, etc.

Furthermore, component B) is soluble in apolar solvents. This is absolutely necessary, since only in that way is it possible to mix the very apolar component A) homogeneously with component B).

Component B) is soluble in 10% and 50% by weight dilution in aromatic solvents such as, for example, xylenes, toluene, benzene, cresols, naphthalene, tetrahydronaphthalene and/or in aliphatic solvents and solvent mixtures, such as decahydronaphthalene, hexane, heptane, (methyl)cyclohexane, Kristalloels, white spirits, terpentines, paraffins, alone or in a mixture.

Component C)

The component C) is used in amounts of 1% to 98%, preferably of 2% to 98%, more preferably of 20% to 98% by weight. The amount of component C) includes all values and subvalues therebetween, especially including 5, 10, 15, 20, 25, 30, 35, 40, 45, 50, 55, 60, 65, 70, 75, 80, 85, 90 and 95% by weight. Mixtures of C) may be used.

Suitable components C), generally speaking, are all organic solvents which are used in the adhesives and coatings industries.

Preference is given, for example, to aromatic, aliphatic and/or cycloaliphatic solvents and solvent mixtures, such as xylenes, toluene, benzene, cresols, naphthalene, tetrahydronaphthalene, decahydronaphthalene, hexane, heptane, (methyl)cyclohexane, Kristalloels, white spirits, terpentines, paraffins, alone or in a mixture.

Component D)

Component D) may be present optionally and is used in amounts of 0% to 97% by weight. The amount of component D) includes all values and subvalues therebetween, especially including 5, 10, 15, 20, 25, 30, 35, 40, 45, 50, 55, 60, 65, 70, 75, 80, 85, 90 and 95% by weight. Mixtures of D) may be used.

Suitable components D) are auxiliaries and additives such as, for example, inhibitors, other organic solvents, water, water-scavenging substances, surface-active substances, such as defoamers, deaerating agents, lubricants, flow control agents, substrate wetting agents, antiblocking agents, oxygen scavengers, free-radical scavengers, catalysts, light stabilizers, color brighteners, photosensitizers, photoinitiators, rheological additives such as thixotropic agents and/or thickeners, antiskinning agents, antistats, wetting agents, dispersants, crosslinkers such as blocked or non-blocked (poly)isocyanates, preservatives such as fungicides and/or biocides, for example, thermoplastic additives, plasticizers, matting agents, flame retardants, internal release agents, blowing agents and/or dyes, pigments and/or fillers and/or ungrafted, readily hydrolysable silanes, for example, hexadecyltrimethoxysilane or hexadecyltriethoxysilane.

Further polymers, moreover, may be present as component D) in amounts up to 40% by weight, examples being polyurethanes, polyacrylates, polyethers, polyesters, alkyd resins, polyamides, casein, cellulose ethers, cellulose derivatives, polyvinyl alcohols and derivatives, polyvinyl acetates, polyvinylpyrrolidones, rubbers, natural resins, hydrocarbon resins such as coumarone resins, indene resins, cyclopentadiene resins, terpene resins, maleate resins, phenolic resins, phenol/urea-aldehyde resins, amino resins (e.g. melamine resins, benzoguanamine resins), epoxy acrylates, epoxy resins, silica esters and alkali metal silicates (e.g. waterglass), silicone resins and/or fluorine-containing polymers. These binders may be externally crosslinking and/or self-crosslinking, air-drying (physically drying) and/or oxidatively curing.

Preparation of the compositions from components A) to D):

The compositions are prepared by intensely mixing the components at temperatures of 20 to 80° C. (“Lehrbuch der Lacktechnologie”, Th. Brock, M. Groteklaes, P. Mischke, ed. V. Zorll, Vincentz Verlag, Hanover, 1998, page 229 ff.), in an inert gas atmosphere and with exclusion of water if desired. This is done by initially introducing component C) and adding components A), B) and, if desired, D). However, any other order of mixing the components is possible.

The compositions of the invention contain components A) to D) which are free from chlorine. Chlorine-free means that no chlorine-containing products containing organically bound chlorine, such as chlorinated rubbers, chlorinated polyolefins or the like, for example, are used. Inorganic chlorides (salts, for example) may, on the other hand, be present, but do not generally possess any toxicological potential.

The invention also provides for the use of the compositions as primer compositions for improving the adhesion to plastics, more particularly to unpretreated plastics.

The compositions of the invention made up of components A) to D) may be used as primer compositions which allow very good adhesion of adhesives, sealants and/or coating materials to unpretreated plastics, so that typical plastics pretreatment methods are unnecessary, examples being flame treatment, corona discharge, plasma treatment or gas-phase fluorination. Accordingly, the simple prior cleaning of the substrates with typical cleaning agents such as isopropanol and/or n-hexane, for example, is sufficient.

The compositions of the invention made up of components A) to D) are particularly suitable as primers for promoting the adhesion of adhesives, sealants and/or coating materials on unpretreated, low-energy plastics which possess a surface tension below 40, preferably below 38, more preferably below 34 mN/m².

Examples that may be mentioned of low-energy plastics of this kind include polyolefins such as, for example, polypropylene (PP), modified polypropylene, such as polypropylene-ethylene copolymers (e.g. block copolymers or random copolymers), poly-1-butene, polyethylene (PE), modified PE, mixtures such as polypropylene/ethylene-propylene-diene blends (PP/EPDM) having a low EPDM content, PP/PE blends, and also rubbers (natural rubbers, butyl rubbers, chloroprene rubber, silicone rubber, EPM, EPDM, NBR, SBR, SBS, BR), polyvinyl chloride or specific polyesters.

The plastics may be workpieces or shaped articles, or composites, such as systems with paper and/or aluminium laminated onto plastic or films, foils or sheets.

The plastics may be used in the commodity sector (e.g. bottles, packs, carrier bags, labels or the like) or for high-value applications (e.g. in the electronics industry, in automotive engineering or in aircraft construction).

A surprise, however, is that the adhesion of subsequent coats to glass, wood, paper, cardboard packaging of all kinds, fiberboard, metals (e.g. iron, steel, stainless steel, aluminium, brass, copper), ceramic or concrete as well is improved by the prior application of the primer compositions of the invention.

The compositions of the invention made up of components A) to D) exhibit a rapid initial drying and a high blocking resistance.

The effect of the pretreatment is also retained over a long time period, so that, optionally, pretreatment directly after the production of the plastic, at the premises of the plastics manufacturer (off-line), or else pretreatment directly prior to application of the coating material (in-line), is possible.

Since the composition of the invention is chemically reactive and is able to react not only with (atmospheric) moisture but also with any hydroxyl-containing components present in the composition and/or with functional groups of the substrate or of the subsequent coats, it is possible for an integrated system to come about, through the formation of covalent bonds to the substrate and to subsequent coats. This results in a very good strength of adhesion, which is retained even at a relatively high temperature.

Depending on the desired effects, the silane groups of component A) can be reacted with any hydroxyl groups present in further components, producing a network. To increase the crosslinking rate it is possible for example to use catalysts, such as organobismuth, organozinc and/or organotin compounds, for example. Examples are bismuth octoates or dibutyltin dilaurate. To reduce the crosslinking reaction and to decrease the crosslinking density it is possible on the other hand—if desired—to add ungrafted, readily hydrolysable silanes such as hexadecyltrimethoxysilane or hexadecyltriethoxysilane, for example. Products of this kind may also scavenge any water that diffuses in. It is advisable here to use relatively high molecular weight silanes, since they possess a high boiling point and therefore do not give rise to problems of disposal or of occupational hygiene.

Depending on the intended use, subsequent adhesives, sealants or coating materials are applied to the primer coats of the invention. This subsequent coat may be applied to the primer directly wet-on-wet, i.e. the solvent is not removed. It is also possible first to free the primer from the volatile constituents, at room temperature or at elevated temperature, and then to apply the subsequent coat to the “dry”—i.e. solvent-free—primer. “Elevated temperature” includes temperatures between 20 and 150° C., preferably between 30 and 80° C.

The composition of the invention can be applied to the plastics substrates using typical methods. Examples thereof include (electrostatic) spraying methods, injecting methods, spincoating, pouring, dipping, drumming, flooding, rolling, wiping, washing, printing, roller coating, spreading and extruding.

The thickness of the primer coats of the invention, following evaporation of the volatile constituents such as solvents, for example, is between 0.01 and 100 μm, preferably 0.1 and 30 μm, more preferably between 0.2 and 10 μm.

As subsequent coating materials it is possible to use all coating materials, more particularly all solvent-containing or aqueous coating materials or solvent-free coating materials (e.g. radiation-curable coating materials and/or powder coating materials) such as, for example, trowelling compounds, surfacers, basecoat materials, topcoat materials, printing inks, ballpoint pen pastes, inks, polishes, glazes, laminated systems, heat-seal lacquers, cosmetics articles, sealants, insulants or adhesives.

The flow of the compositions of the invention on the substrates, and the flow of the subsequent coating materials on the compositions of the invention, is flawless and the surfaces are free from defects such as craters and wetting defects, for example.

The invention also provides articles produced using the silane-group-containing compositions.

Having generally described this invention, a further understanding can be obtained by reference to certain specific examples which are provided herein for purposes of illustration only, and are not intended to be limiting unless otherwise specified.

### EXAMPLES

I.) Component A): Preparation of the Silane-Grafted Polyolefin

A silane-grafted polyolefin was prepared using a largely amorphous poly-α-olefin whose monomer composition was as follows:

6% by weight ethene

64% by weight propene

30% by weight 1-butene

In a twin-screw extruder (Berstorff ZE 40) a mixture composed of 92.9% by weight of this poly-α-olefin,

6.0% by weight of vinyltrimethoxysilane (Dynasilan® VTMO) and

1.1 % by weight of dicumyl peroxide

was mixed at a temperature of about 170° C. in the absence of air and moisture and was held at this temperature for a residence time of approximately 90 s. In the final zone of the extruder the excess VTMO was evaporated off under a vacuum of approximately 20 mbar and was condensed in cold traps. The product was stabilized by the addition of Irganox 1076. The melt viscosity was 6 Pa·s at 190° C. The product was soluble, for example, in xylene, Solvesso® 100 and Shellsol® D40.

II.) Component B)

1. Preparation of the Ketone-Aldehyde Resin

The ketone-aldehyde resin was prepared as in Example GL 254 of EP 1 486 520 A1.

2. Preparation of the Hydrogenated Ketone-Aldehyde Resin

The hydrogenated ketone-aldehyde resin was prepared in accordance with Example 2 of DE 102006026758.3.

3. Preparation of the Urea-Aldehyde Resin

The urea-aldehyde resin was prepared as in Example 1 of DE 27 17 76.

Table 1 below gives an overview of the properties of resins II-1 to II-3.

TABLE 1
Properties of resins II-1 to II-3

| | Resin II-1 | Resin II-2 | Resin II-3 |
|---|---|---|---|
| Hydroxyl number | 7.6 | 16.0 | 19.4 |
| [mg KOH/g] | | | |
| Melting point [° C.] | 63 | 49 | 63 |
| Non-volatiles content | 78.2 | 99.6 | 64.3 |
| (24 h at 150° C.) | | | |
| [% by mass] | | | |
| Gardner color number | 1.0 | 0.0 | 1.1 |
| (50% in ethyl acetate) | | | |
| Gardner color number | 3.9 | 0.2 | 3.2 |
| (after 24 h at 150° C.; | | | |
| 50% in ethyl acetate) | | | |
| Mn (GPC against PS) | 500 | 890 | 1150 |
| [g · mol⁻¹] | | | |
| Mw (GPC against PS) | 670 | 1350 | 4640 |
| [g · mol⁻¹] | | | |
| Polydispersity | 1.3 | 1.5 | 3.0 |
| Solubility (10%/50%) | | | |
| White spirit | clear/clear | clear/clear | clear/clear |
| Isopar H | clear/clear | clear/clear | clear/clear |
| n-Hexane | slightly turbid/clear | clear/clear | slightly |
| | | | turbid/clear |
| Xylene | clear/clear | clear/clear | clear/clear |

Production of the Primer Compositions

The substances indicated in Table 2 below were dissolved and homogenized with stirring. For this purpose the respective solvent (component C)) was taken as the initial charge and the polyolefin I-1 and also the respective resin II-1 to II-3 were added slowly with stirring at room temperature. To accelerate dissolution the solutions were briefly heated to 60° C. with stirring. After dissolution had taken place, the solutions were filtered.

TABLE 2
Composition of comparative C1 and of primers P1 to P8 (all figures in
grams/g)

| | C1 | P1 | P2 | P3 | P4 | P5 | P6 | P7 | P8 |
|---|---|---|---|---|---|---|---|---|---|
| Polyolefin I-1 | 10.0 | 5.0 | 3.3 | 2 | 5.0 | 5.0 | 5.0 | 5.0 | 5.0 |
| Resin II-1 | — | 5.0 | 6.7 | 8 | 5.0 | 5.0 | 5.0 | — | — |
| Resin II-2 | — | — | — | — | — | — | — | 5.0 | — |
| Resin II-3 | — | — | — | — | — | — | — | — | 5.0 |
| Xylene | 90.0 | 90.0 | 90.0 | 90.0 | — | — | — | 90.0 | 90.0 |
| Solvesso ® 100 | — | — | — | — | 90.0 | — | — | — | — |
| Shellsol ® D 40 | — | — | — | — | — | 90.0 | — | — | — |
| White spirit | — | — | — | — | — | — | 90.0 | — | — |

All the solutions were clear to slightly turbid, colorless to yellowish, and water-thin. In the case of the comparative solution C1 the fraction of insoluble constituents was relatively higher than in the case of compositions P1 to P8. This can be explained by the solubilizer effect of the resins II-1 to II-3. C1 represents a direct comparison with WO 2004/078365.

Solutions C1 and P1 to P8 were applied by means of a doctor blade (2 μm wet film) to films which had been cleaned beforehand with ethanol and n-hexane. Following the evaporation of the solvents (various flash-off times; see Table 3) a printing ink was applied to the sheets by knife coating (2 μm wet film) and the films were freed from the solvents at room temperature.

The adhesion properties were assessed using what was called the crumple test. 24 h following application of the printing ink, the coated sheet was “crumpled”. If the coating was undamaged, the adhesion was very good (1). In the case of damage to the coating, the degree of damage was assessed (2: slight flaking, . . . , 6: complete delamination).

In addition, the adhesion was assessed by means of the adhesive tape stripping method (tape test). After different flash-off times for the printing ink (5 min, 1 h, 24 h), an adhesive tape was adhered to the printing ink film and then stripped off again. If the coating was undamaged, the adhesion was very good (1). In the case of damage to the coating, the degree of damage was assessed (2: slight flaking, . . . , 6: complete delamination).

The printing ink used had the following composition:

39.0 g ethanol

11.2 g ethyl acetate

40.0 g Kunstharz 1201 synthetic resin (Degussa AG)

7.2 g Hacolor blue 50423(Hagedom)

The constituents were combined in the stated order, with stirring, and homogenized.

The film substrates (plastering films) used were as follows:

Treofan NNA 40 (PP film), Hostaphan RN 50 (PET film), Genotherm EE 87 (PVC film)

Tables 3-1 and 3-2 below show the results of the adhesion investigations (crumple test, tape test) of the printing inks on the respective primer P1 to P8 in comparison to the printing ink on the respective untreated film and on the comparative primer C1.

TABLE 3-1
Results of the adhesion investigations (crumple test, tape test) of the printing inks
on the respective primer P1 to P8 in comparison with the printing ink on the
respective untreated film and on the comparative primer C1

| | | | | | Tape test | | | | | | | | |
|---|---|---|---|---|---|---|---|---|---|---|---|---|---|
| | | Crumple test | | | PP | | | PET | | | PVC | | |
| Sample | Primer drying conditions | PP | PET | PVC | 5 min | 1 h | 24 h | 5 min | 1 h | 24 h | 5 min | 1 h | 24 h |
| none | no primer (comparative) | 6 | 6 | 4 | 6 | 6 | 6 | 6 | 6 | 5 | 4-5 | 3-4 | 3 |
| C1 | 0.5 min RT | 6 | 6 | 5 | 6 | 6 | 6 | 6 | 6 | 6 | 6 | 5 | 5 |
| | 1 min RT | 2-3 | 5 | 4-5 | 4 | 3 | 2-3 | 6 | 5-6 | 5 | 5 | 4-5 | 4 |
| | 2 min RT | 2-3 | 4 | 3 | 2-3 | 2 | 2 | 6 | 5 | 4 | 3 | 3 | 2-3 |
| P1 | 0.5 min RT | 5 | 3-4 | 3 | 4 | 4 | 3 | 5 | 3-4 | 3 | 2-3 | 3 | 2 |
| | 1 min RT | 2 | 2 | 3 | 1-2 | 1 | 1 | 3 | 2 | 1 | 3 | 2 | 1 |
| | 2 min RT | 1 | 1 | 1 | 1-2 | 1 | 1 | 1 | 1 | 1 | 1 | 1 | 1 |
| P2 | 0.5 min RT | 5 | 3 | 3 | 4 | 3 | 3 | 5 | 3 | 3 | 3 | 2 | 2 |
| | 1 min RT | 1 | 2-3 | 2 | 1 | 1 | 1 | 2 | 2 | 1 | 2 | 2 | 1-2 |
| | 2 min RT | 1 | 1 | 1 | 1 | 1 | 1-2 | 1 | 1 | 1 | 1-2 | 1-2 | 1-2 |
| P3 | 0.5 min RT | 3 | 3 | 2 | 3 | 3 | 2 | 4 | 3 | 2 | 3 | 2 | 2 |
| | 1 min RT | 1-2 | 2 | 2 | 1 | 1 | 1 | 2 | 2 | 1 | 2 | 1-2 | 1 |
| | 2 min RT | 1 | 1 | 1 | 1 | 1 | 1 | 1 | 1 | 1 | 1 | 1 | 1 |
| P4 | 0.5 min RT | 5 | 4 | 3 | 4 | 4 | 3-4 | 5 | 4 | 3 | 3 | 3 | 2 |
| | 1 min RT | 2-3 | 2 | 2-3 | 1-2 | 2 | 1-2 | 3-4 | 1-2 | 1 | 2-3 | 3 | 2 |
| | 2 min RT | 1-2 | 1 | 1 | 1-2 | 1 | 1 | 1-2 | 1 | 1 | 1 | 1 | 1 |

TABLE 3-2
Results of the adhesion investigations (crumple test, tape test) of the printing inks on
the respective primer P1 to P8 in comparison with the printing ink on the respective
untreated film and on the comparative primer C1

| | | | | | Tape test | | | | | | | | |
|---|---|---|---|---|---|---|---|---|---|---|---|---|---|
| | | Crumple test | | | PP | | | PET | | | PVC | | |
| Sample | Primer drying conditions | PP | PET | PVC | 5 min | 1 h | 24 h | 5 min | 1 h | 24 h | 5 min | 1 h | 24 h |
| P5 | 0.5 min RT | 4 | 4 | 3 | 3-4 | 3-4 | 3 | 5 | 4 | 3 | 3 | 3 | 2 |
| | 1 min RT | 2 | 2-3 | 2-3 | 2 | 2 | 1 | 3 | 2 | 1 | 3 | 2-3 | 2 |
| | 2 min RT | 1 | 1 | 1 | 1-2 | 1 | 1 | 1-2 | 1 | 1 | 1-2 | 1-2 | 1 |
| P6 | 0.5 min RT | 4 | 5 | 3-4 | 3 | 3 | 3 | 4 | 4 | 3 | 4 | 4 | 2-3 |
| | 1 min RT | 2-3 | 3 | 3 | 2 | 1 | 1 | 3 | 2 | 1 | 3 | 3 | 2 |
| | 2 min RT | 1 | 1 | 1 | 1 | 1 | 1 | 2 | 1 | 1 | 1-2 | 1-2 | 1 |
| P7 | 5 min RT | 1-2 | 1-2 | 1-2 | 1-2 | 1 | 1 | 2 | 1 | 1-2 | 1-2 | 1 | 1 |
| P8 | 0.5 min RT | 4 | 3 | 4 | 4 | 3 | 2 | 4 | 4 | 3 | 3 | 3 | 2 |
| | 1 min RT | 2 | 3 | 3 | 1-2 | 1-2 | 1 | 3 | 2 | 1-2 | 3 | 2-3 | 2 |
| | 2 min RT | 1 | 1-2 | 1 | 1 | 1 | 1 | 1 | 1-2 | 1 | 2-3 | 1-2 | 1 |

RT = room temperature

In the absence of a primer coat the adhesion of the printing ink to the respective plastic was poor. This was evident from the results of the crumple tests and the tape tests. Only on PVC was a minimally improved adhesion found (tape test 3 after 24 h). The comparative experiment C1 shows that a primer without component B) can in fact fundamentally improve the adhesion. However, a relative improvement was observed only after a flash-off time of 2 minutes, and was not at a very high level. In contrast, the adhesion of the printing ink to the plastics substrates was significantly improved by the primer coats of the invention even after short flash-off times.

It was evident that a higher concentration of component B) (P1 to P3) was beneficial for the adhesion after short flash-off times. Since all of these primer coatings were already tack-free after 30 seconds, a high blocking resistance after a very short time was ensured.

Examples P4 to P6 show no significant differences in comparison to P1. The differences lie within the region of the accuracy of the relative methods. Therefore the effect of the solvent used (component C)) was small.

Solutions C1 and P1 to P8 were applied by means of a doctor blade (2 μm wet film) to polyethylene and polypropylene panels from Krüppel that had been cleaned beforehand with ethanol and n-hexane. Following the removal of the solvents by evaporation, a printing ink was applied by means of a doctor blade (2 μm wet film) and freed from the solvent at RT. In addition, a standard commercial two-component polyurethane varnish was applied to the panels by spray application and was dried at 80° C. for 30 minutes.

The adhesion properties of the printing inks were assessed by means of the adhesive tape stripping method (tape test). For that purpose an adhesive tape, after different flash-off times of the printing ink (5 min, 1 h, 24 h), was adhered to the printing ink film and then stripped off again. If the coating was undamaged, the adhesion was very good (1). In the event of damage to the coating the degree of the damage was assessed (2: slight flaking, . . . , 6: complete delamination).

The applied coating materials were subjected to cross-hatch testing along the lines of DIN EN ISO 2409 (GT 0, very good, GT 5 complete delamination).

The results are set out in Table 4.

TABLE 4
Results of the adhesion investigations of 2-component varnishes
(cross-hatch testing) and the printing inks (tape test) on the
respective primer P1 to P8 in comparison to the varnish/printing
ink on the particular untreated panel and on the comparative primer C1

| | | Cross- | | Tape test | | | | | |
|---|---|---|---|---|---|---|---|---|---|
| | Primer drying | hatch | | PE | | | PP | | |
| Sample | conditions | PE | PP | 5 min | 1 h | 24 h | 5 min | 1 h | 24 h |
| none | no primer | 5 | 5 | 6 | 6 | 6 | 6 | 6 | 6 |
| | (comparative) | | | | | | | | |
| C1 | 5 min RT | 5 | 5 | 6 | 6 | 6 | 3 | 3 | 3 |
| | 30 min 100° C. | 4 | 3 | 4-5 | 3 | 2 | 3 | 2-3 | 2 |
| P1 | 5 min RT | 4 | 1 | 4 | 3 | 3 | 1 | 1 | 1 |
| | 30 min 100° C. | 1 | 0 | 1 | 1 | 1 | 1 | 1 | 1 |
| P2 | 5 min RT | 4 | 1 | 4 | 3 | 3 | 1 | 1 | 1 |
| | 30 min 100° C. | 2 | 0 | 2 | 1-2 | 1-2 | 1 | 1 | 1 |
| P3 | 5 min RT | 4 | 1 | 3 | 3 | 3 | 1 | 1 | 1 |
| | 30 min 100° C. | 2-3 | 0-1 | 2 | 1-2 | 1-2 | 1 | 1 | 1 |
| P4 | 5 min RT | 4 | 2 | 4 | 3-4 | 3-4 | 1 | 1 | 1 |
| | 30 min 100° C. | 2-3 | 0 | 2 | 1 | 1 | 1 | 1 | 1 |
| P5 | 5 min RT | 3-4 | 1-2 | 4 | 3 | 3 | 1 | 1 | 1 |
| | 30 min 100° C. | 2 | 0-1 | 1 | 1 | 1 | 1 | 1 | 1 |
| P6 | 5 min RT | 4 | 2 | 4 | 3 | 3 | 1 | 1 | 1 |
| | 30 min 100° C. | 2 | 0-1 | 1-2 | 1 | 1 | 1 | 1 | 1 |
| P7 | 5 min RT | 4 | 3 | 4 | 4 | 4 | 1 | 1 | 1 |
| | 30 min 100° C. | 3 | 2 | 3 | 2-3 | 3 | 1 | 1 | 1 |
| P8 | 5 min RT | 4 | 1-2 | 3 | 3 | 3 | 1 | 1 | 1 |
| | 30 min 100° C. | 3 | 0-1 | 1 | 1 | 1 | 1 | 1 | 1 |

In the absence of a primer coat the adhesion of the two-component polyurethane varnish to the respective plastic was poor. The same results arise from pretreatment by means of the comparative primer C1. In all cases there was no adhesion (cross-hatch GT 5).

On PE the adhesion, by pretreatment using the inventive primers P1 to P8, was not improved if the primer had been freed from the solvent at room temperature. However, where the inventive primers P1 to P8 were freed from the solvent at an elevated temperature, the resulting adhesion results for the two-component varnish on PE were significantly improved.

On PP the inventive primers P1 to P8 produce outstanding improvements in the adhesion of the varnish. Here as well, however, the tendency was that evaporation of the solvent at an elevated temperature was able to produce a further improvement in the adhesion properties.

In the absence of a primer coat the adhesion of the printing ink to the respective plastic was likewise poor (tape test 6). The pretreatment of PE by means of C1 exhibits no improvement after 5-minute evaporation of the solvents at RT. A slight improvement was found, in contrast, after forced drying of the primer. On PP, improvements were found by the pretreatment with C1.

Where the inventive primers were freed from the solvent at RT, the result for PE was improved adhesion properties of the printing ink on the respective primer. As a result of the forced drying at 100° C. of the respective primer, very good adhesion properties of the printing ink on the thus-pretreated PE panels were found. In the case of PP, the adhesion was always outstanding, irrespective of the temperature during evaporation of the solvents.

Here again, examples P4 to P6 show no significant differences in comparison to P1. The influence of the solvent used (component C)) was therefore low.

The primer P1 was applied to Treofan NNA 40(PP film) as described above. The printing ink, however, was not applied until 3 or 6 months following application of the primer. The investigation of the adhesion properties shows no differences in comparison to the investigations following direct application of the printing ink. This therefore demonstrates that the adhesion-promoting effect remains constant even over a long period (cf. Table 5).

TABLE 5
Results of the adhesion investigations (crumple test, tape test)
of the printing ink on the primer P1 on Treofan NNA 40 after
2 minutes and after 3 or 6 months of application of the primer

| | Primer drying | Crumple | Tape test | | |
|---|---|---|---|---|---|
| Sample | conditions | test | 5 min | 1 h | 24 h |
| P1 | 2 min RT | 1 | 1-2 | 1 | 1 |
| | 3 months RT | 0 | 1-2 | 1 | 1 |
| | 6 months RT | 0-1 | 1 | 1 | 1 |

The primer P1 was applied to Treofan NNA 40(PP film) as described above. The printing ink, however, was not applied until 2 minutes following application of the primer. The film was stored at 60 or 80° C. for 1 hour. After a wait of 1 minute at room temperature, the tape test and crumple test were carried out. The values correspond to those shown in Table 3-1. The experiment was repeated with C1. In this case the adhesion of the printing ink was much lower. This therefore demonstrates that the adhesion through the composition of the invention was retained even at a high temperature (Table 6).

TABLE 6
Results of the adhesion investigations (crumple test, tape test)
of the printing ink on the primer P1 and C1 on Treofan NNA 40
after storage at 60 and 80° C.

| | Primer drying | Crumple | Tape test | | |
|---|---|---|---|---|---|
| Sample | conditions | test | 5 min | 1 h | 24 h |
| P1 | 1 h 60° C. | 1 | 1-2 | 1 | 1 |
| P1 | 1 h 80° C. | 1 | 2 | 1 | 1 |
| C1 | 1 h 60° C. | 4 | 5 | 5 | 4 |
| C1 | 1 h 80° C. | 5 | 6 | 5 | 5 |

German patent application 10 2006 044 143.5 filed Sep. 15, 2006, is incorporated herein by reference.

Numerous modifications and variations on the present invention are possible in light of the above teachings. It is therefore to be understood that within the scope of the appended claims, the invention may be practiced otherwise than as specifically described herein.

1. A silane-group-containing composition, comprising:
no organically bound chlorine;
A) 1% to 98% by weight of at least one silane-grafted, largely amorphous poly-α-olefin which comprises no organically bound chlorine and has an enthalpy of fusion in the range from 0 to 80 J/g;
B) 1% to 98% by weight of at least one resin selected from the group consisting of ketone resin, ketone/aldehyde resin, urea/aldehyde resin, hydrogenated ketone resin, hydrogenated ketone/aldehyde resin, hydrogenated urea/aldehyde resin and mixtures thereof;
C) 1% to 98% by weight of at least one solvent; and
D) optionally, up to 97% by weight of at least one auxiliary or adjuvant, the sum of components A) to D) being 100% by weight.

2. The silane-group-containing composition according to claim 1, wherein component A) comprises a member selected from the group consisting of atactic polypropylene, atactic poly-1-butene, a copolymer of the following monomer composition, a terpolymer of the following monomer composition and mixtures thereof,
said monomer composition comprising
0% to 95% by weight of one or more α-olefins having 4 to 20 carbon atoms;
5% to 100% by weight of propene; and
0% to 50% by weight of ethane.

3. The silane-group-containing composition according to claim 1, wherein said α-olefin of component A) having 4 to 20 carbon atoms is selected from the group consisting of 1-butene, 1-pentene, 1-hexene, 1-octene, 1-decene, 1-dodecene, 1-octadecene, 3-methyl-1-butene, a methylpentene, a methylhexene, a methylheptene and mixtures thereof.

4. The silane-group-containing composition according to claim 1, wherein a silane which carries three alkoxy groups joined directly to the silicon is used as silane for graft attachment to prepare component A).

5. The silane-group-containing composition according to claim 1, comprising vinyltrimethoxysilane (VTMO), vinyltriethoxysilane, vinyltris(2-methoxyethoxy)-silane, 3-methacryloyloxypropyltrimethoxysilane (MEMO), 3-methacryloyloxypropyltriethoxysilane, vinyldimethylmethoxysilane, vinylmethyldibutoxysilane or mixtures thereof.

6. The silane-group-containing composition according to claim 1, wherein the silane is used in amounts between 0.1% to 10% by weight, based on the polyolefin.

7. The silane-group-containing composition according to claim 1, wherein said component A) is at least one silane-grafted, mainly amorphous poly-α-olefins comprising no organically bound chlorine, having
a weight-average molecular weight of 2000 to 250 000 g/mol,
a polydispersity of 2.0 to 40,
a glass transition temperature of −80 to 0° C.,
an enthalpy of fusion in the range from 0 to 80 J/g, and
substantial solubility and/or swellability in an apolar solvent.

8. The silane-group-containing composition according to claim 1, wherein C—H-acidic ketones are used to prepare the ketone resin and/or ketone-aldehyde resin of component B).

9. The silane-group-containing composition according to claim 1, wherein, as a starting compound, at least one ketone selected from the group consisting of acetone, acetophenone, methyl ethyl ketone, tert-butyl methyl ketone, heptanone, heptan-2-one, pentan-3-one, methyl isobutyl ketone, cyclopentanone, cyclododecanone, mixtures of 2,2,4- and 2,4,4-trimethylcyclopentanone, cycloheptanone, cyclooctanone, cyclohexanone, 4 tert-amylcyclohexanone, 2-sec-butylcyclohexanone, 2-tert-butylcyclohexanone, 4-tert-butylcyclohexanone, 2-methylcyclohexanone, 3,3,5-tri-methylcyclohexanone and mixtures thereof, is used to prepare said ketone-aldehyde resin of component B).

10. The silane-group-containing composition according to claim 1, wherein cyclohexanone is used to prepare the ketone resin of component B).

11. The silane-group-containing composition according to claim 1, wherein an aldehyde selected from the group consisting of formaldehyde, acetaldehyde, n-butyraldehyde, isobutyraldehyde, valeraldehyde, dodecanal and mixtures thereof, is used to prepare the ketone-aldehyde resin of component B).

12. The silane-group-containing composition according to claim 1, wherein formaldehyde, para-formaldehyde, trioxane or mixtures thereof are used as an aldehyde component to prepare the ketone-aldehyde resin of component B).

13. The silane-group-containing composition according to claim 1, wherein i) a resin from acetophenone, cyclohexanone, 4-tert-butylcyclohexanone, 3,3,5-trimethylcyclohexanone, heptanone, or mixtures thereof and ii) formaldehyde are used as component B).

14. The silane-group-containing composition according to claim 1, wherein said component B) is a hydrogenated resin.

15. The silane-group-containing composition according to claim 1, wherein said component B) is a hydrogenated derivative of a resin comprising in polymerized form i) acetophenone, cyclohexanone, 4-tert-butylcyclohexanone, 3,3,5-trimethylcyclohexanone, heptanone, or mixtures thereof, and ii) formaldehyde.

16. The silane-group-containing composition according to claim 1, wherein that an urea-aldehyde resin prepared using a urea of the general formula (i) 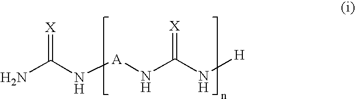
in which X is oxygen or sulphur, A is an alkylene radical and n is 0 to 3 with 1.9(n+1) to 2.2(n+1) mol of an aldehyde of the general formula (ii) 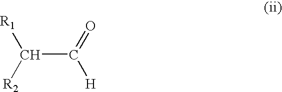
in which R₁ and R₂ stand for hydrocarbon radicals having in each case up to 20 carbon atoms, and/or formaldehyde, are used as component B).

17. The silane-group-containing composition according to claim 1, wherein an urea-aldehyde resin prepared using urea, thiourea, methylenediurea, ethylenediurea, tetramethylenediurea, hexamethylenediurea or mixtures thereof are used as component B).

18. The silane-group-containing composition according to claim 1, wherein urea-aldehyde resins prepared using isobutyraldehyde, formaldehyde, 2-methylpentanal, 2-ethylhexanal, 2-phenylpropanal or mixtures thereof are used as component B).

19. The silane-group-containing composition according to claim 1, wherein an urea-aldehyde resin prepared using urea, isobutyraldehyde and formaldehyde are used as component B).

20. The silane-group-containing composition according to claim 1, wherein said component B) has the following characteristics:
a hydroxyl number between 0 and 450 mg KOH/g;
a Gardner color number (50% by weight in ethyl acetate) between 0 and 5;
a Gardner color number (50% by weight in ethyl acetate) after thermal exposure of
the resin (24 h, 150° C.) between 0 and 10.0;
a number-average molecular weight, Mn, of 300 to 10 000 g/mol;
a polydispersity (Mw/Mn) between 1.25 and 4.0;
a melting point/range between 20 and 180° C.; and
a solubility in an apolar organic solvent.

21. The silane-group-containing composition according to claim 1, wherein organic solvents are used as component C).

22. The silane-group-containing composition according to claim 1, wherein at least one aromatic, aliphatic and/or cycloaliphatic solvent selected from the group consisting of xylenes, toluene, benzene, cresols, naphthalene, tetrahydronaphthalene, decahydronaphthalene, hexane, heptane, (methyl)cyclohexane, Kristalloels, special-boiling-point spirits, white spirits, terpentines, paraffins, and mixtures thereof, are used as component C).

23. The silane-group-containing composition according to claim 1, wherein at least one auxiliary, additive or mixture thereof is used as component D).

24. The silane-group-containing composition according to claim 1, wherein at least one auxiliary and/or additive selected from the group consisting of inhibitors, organic solvents which may be the same or different from the solvent of component C), water, water-scavenging substances, surface-active substances, defoamers, deaerating agents, lubricants, flow control agents, substrate wetting agents, antiblocking agents, oxygen scavengers, free-radical scavengers, catalysts, light stabilizers, color brighteners, photosensitizers, photoinitiators, rheological additives, antiskinning agents, antistats, wetting agents, dispersants, crosslinkers, preservatives, thermoplastic additives, plasticizers, matting agents, flame retardants, release agents, blowing agents, dyes, pigments, fillers, ungrafted, readily hydrolysable silanes such as hexadecyltrimethoxysilane or hexadecyltriethoxysilane, polyurethanes, polyacrylates, polyethers, polyesters, alkyd resins, polyamides, casein, cellulose ethers, cellulose derivatives, polyvinyl alcohols and polyvinyl alcohol derivatives, polyvinyl acetates, polyvinylpyrrolidones, rubbers, natural resins, hydrocarbon resins, terpene resins, maleate resins, phenolic resins, phenol/urea-aldehyde resins, amino resins, epoxy acrylates, epoxy resins, silicic esters and alkali metal silicates, silicone resins, fluorine-containing polymers and mixtures thereof, are used as component D).

25. The silane-group-containing composition according to claim 1, which exhibits rapid initial drying and high blocking resistance.

26. A process for preparing a silane-group-containing composition according to claim 1, comprising:
by intensely mixing and homogenizing components A) to C) and optionally D) by stirring and/or dispersing at a temperature of +20 to +80° C., with exclusion of water and optionally in an inert-gas atmosphere, component C) being introduced initially and components A), B) and, optionally, D) being added.

27. A method of promoting adhesion to a plastic, comprising:
contacting said plastic with a silane-group-containing composition according to claim 1, thereby obtaining a coating.

28. The method of claim 27, wherein said plastic is unpretreated plastic.

29. The method of claim 27, wherein said plastic is unpretreated, low-energy plastic, having a surface tension below 40 mN/m².

30. The method of claim 27, wherein said plastic is unpretreated, low-energy plastic selected from the group consisting of polypropylene (PP), modified polypropylene, poly-1-butene, polyethylene, modified PE (PE), polypropylene/ethylene-propylene-diene blends (PP/EPDM) having a low EPDM content, PP/PE blends, rubbers, polyvinyl chloride, polyesters and combinations thereof.

31. A method of promoting adhesion to a material, comprising:
contacting said material with a silane-group-containing composition according to claim 1;
wherein said material is selected from the group consisting of glass, wood, paper, cardboard packaging of all kinds, fiber board, metals, ceramic, concrete and combinations thereof.

32. The method of claim 27, wherein a pretreatment takes place directly after the production of the plastic at the premises of the plastics manufacturer (off-line) or else directly prior to the application of said silane-group-containing composition (in-line).

33. The method of claim 27, wherein said composition is applied to the plastic substrate by a spraying method, injecting method, spincoating, pouring, dipping, drumming, flooding, rolling, wiping, washing, printing, roller coating, spreading, extruding or combinations thereof.

34. The method of claim 27, further comprising applying an adhesive, sealant, coating material or combinations thereof to said plastic.

35. The method of claim 34, wherein a subsequent coat is applied directly wet-on-wet to a coat of said silane-group-containing composition, or
the coat of said silane-group-containing composition is first freed from volatile constituents, at room temperature or at elevated temperature, thereby obtaining a dried coat of said silane-group-containing composition and then the subsequent coat is applied to the dried coat of said silane-group-containing composition.

36. The method of claim 27, wherein a thickness of the coating after the volatile constituents have evaporated is between 0.01 and 100 μm.

37. The method of claim 35, wherein said subsequent coat comprises a member selected from the group consisting of sealants, adhesives, coating materials mixtures thereof;
wherein said coating materials are selected from the group consisting of solvent-containing systems, aqueous systems, solvent-free systems.

38. The method of claim 35, wherein said subsequent coat comprises a member selected from the group consisting of radiation-curable adhesives, sealants, coating materials, coating materials and mixtures thereof are used as subsequent systems.

39. The method of claim 35, wherein said subsequent coat comprises a member selected from the group consisting of trowelling compounds, surfacers, basecoat materials, topcoat materials, printing inks, ballpoint pen pastes, inks, polishes, glazes, lamination systems, heat-seal lacquers, cosmetics articles, sealants, insulants, adhesives and combinations thereof.

40. An article, comprising: a silane-group-containing composition according to claim 1.
